(19) United States
(12) Patent Application Publication
(10) Pub. No.: US 2011/0198376 A1
(43) Pub. Date: Aug. 18, 2011

(54) SHOPPING CART DEVICE

(76) Inventor: Scott OH, Rancho Cucamonga, CA (US)

(21) Appl. No.: 12/707,605

(22) Filed: Feb. 17, 2010

(51) Int. Cl. B60R 9/00

(52) U.S. Cl. 224/411

(57) ABSTRACT

A shopping cart device includes a shopping bag, hook devices, supporting bars, handles, and fasteners. The shopping bag has an opening surrounded by a rim portion. The hook devices are attached to the rim portion of the shopping bag and configured to engage the shopping cart so as to hold the shopping bag in place on the shopping cart. The supporting bars are fixed to the part of the rim portion of the shopping bag, and each of the pair of hook devices is fixed to a corresponding one of the supporting bars. The handles are fixed to a corresponding one to the supporting bars. The fasteners are fixed to a part of the supporting bars, and the fasteners are configured to stick together detachably when unhooked from the shopping cart.

### BACKGROUND OF THE INVENTION

The present invention relates to a shopping cart device.

People have used many types of shopping bags. In the country, plastic bags have been used widely as an alternative shopping bag.

However, in some of the states, the plastic bags are going to be prohibited for environmental reasons, for the disposable plastic bags are not decomposed easily.

Therefore, reusable shopping bags are needed for convenience of shopping and also for environmental concerns. Many types of shopping bags for attacking such problems have been proposed, but they could not solve all the problems related to a convenience.

Accordingly, a need for a shopping cart device has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a shopping cart device.

Another object of the invention is to provide a shopping cart device, which can be hooked easily to a regular shopping cart.

An aspect of the invention provides a shopping cart device for being hooked up to a shopping cart.

The shopping cart device comprises a shopping bag, a pair of hook devices, a pair of supporting bars, a pair of handles, and a pair of fasteners.

The shopping bag has an opening surrounded by a rim portion.

The pair of hook devices are attached to the rim portion of the shopping bag and configured to engage the shopping cart so as to hold the shopping bag in place on the shopping cart.

The pair of supporting bars are fixed to the part of the rim portion of the shopping bag, and each of the pair of hook devices is fixed to a corresponding one of the pair of supporting bars.

The pair of handles are fixed to a corresponding one to the pair of supporting bars.

The pair of fasteners are fixed to a part of the supporting bars, and the pair of fasteners are configured to stick together detachably when unhooked from the shopping cart.

The rim portion of the shopping bag may comprise two or more resilient portions configured to shorten under no strain.

The two or more resilient portions may comprise a plurality of rubber bands.

The one of the pair of hook devices may comprise one or more hooks configured to be hooked to an edge of the shopping cart.

Each of the one or more hooks may have a U-shape.

The pair of supporting bars may be embedded the the rim portion of the shopping bag.

The pair of supporting bars may be positioned on the rim portion so as to make the opening rectangular in shape.

Each of the pair of handles may be integrated with a corresponding one of the pair of the supporting bars.

The pair of the fasteners may comprise hook and loop fasteners.

Alternatively, the pair of the fasteners may comprise a plurality of magnets.

Alternatively, the pair of the fasteners may comprise a plurality of snap fasteners.

The advantages of the present invention are: (1) the shopping cart device is easy to hook up to a shopping cart; and (2) the shopping cart device is adaptable to regular shopping carts of many types.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a shopping cart device installed in a regular shopping cart according to an embodiment of the invention;

FIG. 2 is a perspective front view of a shopping cart device with an opening closed according to another embodiment of the invention;

FIG. 3 is a perspective view of a hook device according to an embodiment of the invention;

FIG. 4 is a perspective view of a hook device with a hook installed on a shopping cart according to an embodiment of the invention;

FIG. 5 is a perspective view of a hook device with two hooks installed on a shopping cart according to an embodiment of the invention;

FIG. 6 is a perspective front view of a shopping cart device with an opening closed according to another embodiment of the invention;

FIG. 7 is a plan view of a fastener according to an embodiment of the invention;

FIG. 8 is a plan view of a fastener according to another embodiment of the invention; and

FIG. 9 is a plan view of a fastener according to still another embodiment of the invention.

### DETAILED DESCRIPTION EMBODIMENTS OF THE INVENTION

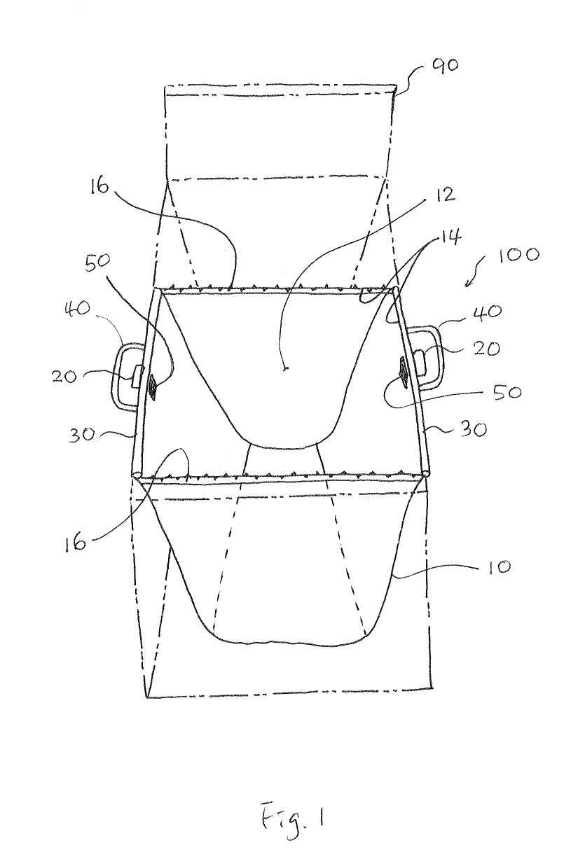

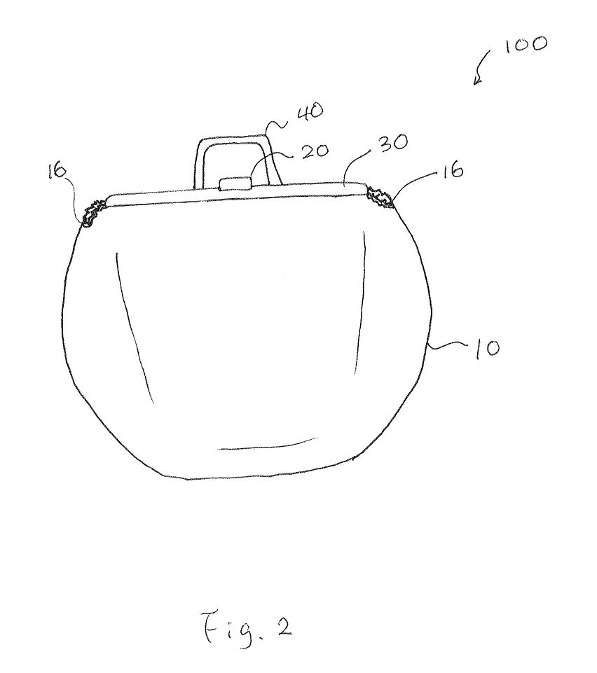

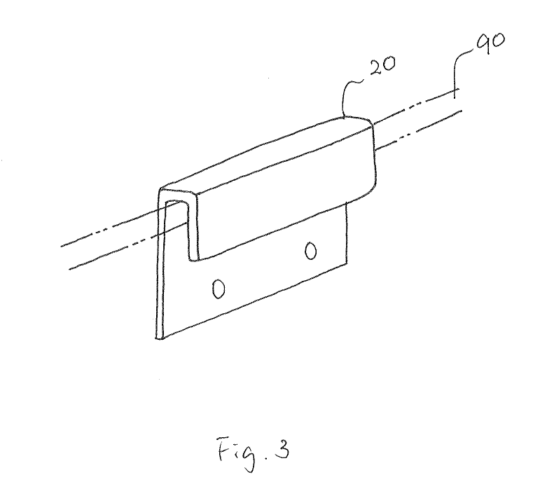

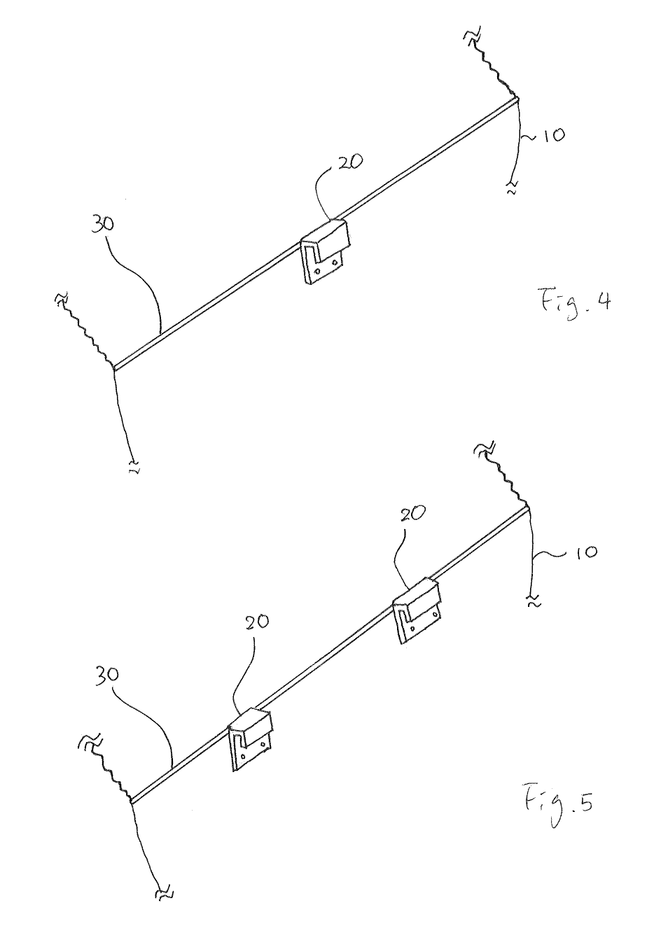

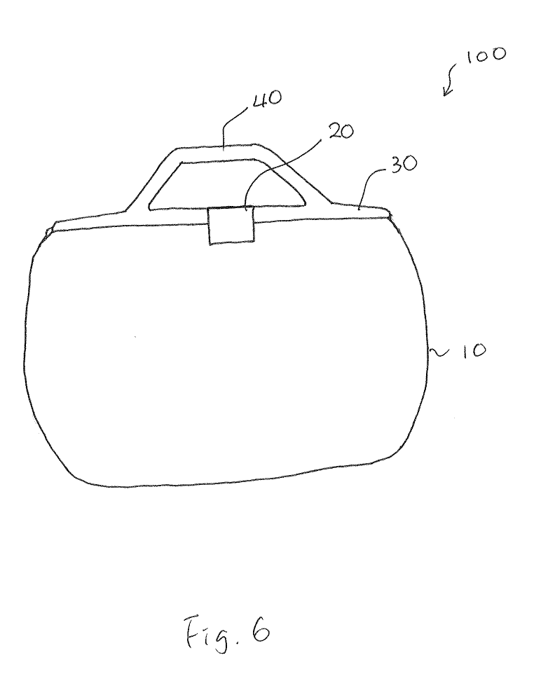

FIG. 1 is a perspective view showing a shopping cart device installed in a regular shopping cart according to an embodiment of the invention. FIG. 2 is a perspective front view of a shopping cart device with an opening closed according to another embodiment of the invention. FIG. 3 is a perspective view of a hook device according to an embodiment of the invention. FIGS. 4 and 5 shows perspective views of hook devices installed on a shopping cart according to embodiments of the invention. FIG. 5 is a perspective view of a hook device with two hooks installed on a shopping cart according to an embodiment of the invention. FIG. 6 is a perspective front view of a shopping cart device with an opening closed according to another embodiment of the invention. FIGS. 7-9 show plan views of fasteners according to embodiments of the invention.

The shopping cart device 100 comprises a shopping bag 10, a pair of hook devices 20, a pair of supporting bars 30, a pair of handles 40, and a pair of fasteners 50 as shown in FIG. 1.

The shopping bag 10 has an opening 12 surrounded by a rim portion 14. The size of the shopping bag 10 is big enough to hold shopping stuffs and small enough to be fitted into a the shopping cart 90 as shown in FIG. 1.

The pair of hook devices 20 are attached to the rim portion 14 of the shopping bag 10 and configured to engage the shopping cart 90 so as to hold the shopping bag 10 in place on the shopping cart 90.

The pair of supporting bars 30 are fixed to the part of the rim portion 14 of the shopping bag 10, and each of the pair of hook devices 20 is fixed to a corresponding one of the pair of supporting bars 30. The pair of supporting bars 30 are for making a shape of the opening 12 when installed in the shopping cart 90.

The pair of handles 40 are fixed to a corresponding one to the pair of supporting bars 30. The handles 40 are used to lift up or carry around the shopping bag 10.

The pair of fasteners 50 are fixed to a part of the supporting bars 30, and the pair of fasteners 50 are configured to stick together detachably when the shopping cart device 100 unhooked from the shopping cart 90.

The rim portion 14 of the shopping bag 10 may comprise two or more resilient portions 16 configured to shorten under no strain. The two or more resilient portions 16 may comprise a plurality of rubber bands, such that the rim portion 14 gets shortened to make the opening 12 small enough not to spill the shopped stuffs out of the shopping bag 10.

The one of the pair of hook devices 20 may comprise one or more hooks configured to be hooked to an edge of the shopping cart 90 as shown in FIGS. 4 and 5.

In certain embodiments of the invention, the hook devices 20 can be a single hook, but have a dimension extending to full length of the supporting bar 30. For example, the two hooks in FIG. 5 can be connected into one.

Each of the one or more hooks may have a U-shape as shown in FIGS. 3-5.

The pair of supporting bars 30 may be embedded the the rim portion 14 of the shopping bag 10.

In certain embodiments of the invention, the shopping bag 10 may be made of fabric, and the supporting bars 30 may be embedded in a hole (not shown) provided in the rim portion 14 of the shopping bag 10.

The pair of supporting bars 30 may be positioned on the rim portion 14 so as to make the opening 12 rectangular in shape.

Each of the pair of handles 40 may be integrated with a corresponding one of the pair of the supporting bars 30 as shown in FIG. 6.

The pair of the fasteners 50 may comprise hook and loop fasteners as shown in FIG. 7.

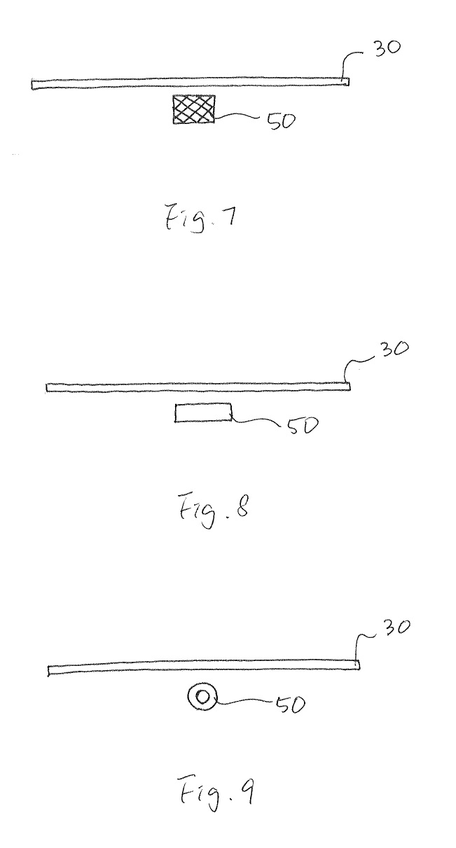

Alternatively, the pair of the fasteners 50 may comprise a plurality of magnets as shown in FIG. 8.

Alternatively, the pair of the fasteners 50 may comprise a plurality of snap fasteners as shown in FIG. 9.

In certain embodiments, the shopping bag 10 may be made of durable plastic or polymers.

In certain embodiments of the invention, the resilient portions 16 may include a rubber band embedded in a portion of the rim portion 14 of the shopping bag 10.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A shopping cart device for being hooked up to a shopping cart, the shopping cart device comprising:
a shopping bag with an opening surrounded by a rim portion;
a pair of hook devices, each of which being attached to a part of the rim portion of the shopping bag and configured to engage the shopping cart so as to hold the shopping bag in place on the shopping cart;
a pair of supporting bars, each of which being fixed to the part of the rim portion of the shopping bag, wherein each of the pair of hook devices is fixed to a corresponding one of the pair of supporting bars;
a pair of handles, each of which being fixed to a corresponding one to the pair of supporting bars; and
a pair of fasteners, each of which being fixed to a part of the supporting bars, wherein the pair of fasteners are configured to stick together detachably when unhooked from the shopping cart.

2. The shopping cart device of claim 1, wherein the rim portion of the shopping bag comprises two or more resilient portions configured to shorten under no strain.

3. The shopping cart device of claim 2, wherein the two or more resilient portions comprise a plurality of rubber bands.

4. The shopping cart device of claim 1, wherein one of the pair of hook devices comprises one or more hooks configured to be hooked to an edge of the shopping cart.

5. The shopping cart device of claim 4, wherein each of the one or more hooks has a U-shape.

6. The shopping cart device of claim 1, wherein the pair of supporting bars are embedded the the rim portion of the shopping bag.

7. The shopping cart device of claim 6, wherein the pair of supporting bars are positioned on the rim portion so as to make the opening rectangular in shape.

8. The shopping cart device of claim 1, wherein each of the pair of handles are integrated with a corresponding one of the pair of the supporting bars.

9. The shopping cart device of claim 1, wherein the pair of the fasteners comprise hook and loop fasteners.

10. The shopping cart device of claim 1, wherein the pair of the fasteners comprise a plurality of magnets.

11. The shopping cart device of claim 1, wherein the pair of the fasteners comprise a plurality of snap fasteners.
